(19) United States
(12) Patent Application Publication
(10) Pub. No.: US 2007/0289083 A1
(43) Pub. Date: Dec. 20, 2007

(54) Apparatus for cleaning article

(75) Inventors: Tsai-Shih Tung, Tu-Cheng (TW); Hsin-Ho Lee, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,915

(22) Filed: Oct. 27, 2006

(30) Foreign Application Priority Data
Jun. 14, 2006 (CN) 200610061131.6

(51) Int. Cl. B05C 21/00

(52) U.S. Cl. 15/257.01

(57) ABSTRACT

An apparatus for cleaning an article includes a cover and a main body defining at least one upper through hole and at least one lower through hole in communication with the at least one upper through hole configured for accommodating the article. The cover defines at least one through hole positioned spatially corresponding to the at least one upper through hole of the main body. The main body and the cover are configured for attachment to each other in a manner such that the at least upper through hole of the main body is aligned with the at least one through hole of the cover. The at least one upper through hole is of such dimensions that the article accommodated therein is held from falling out through the at least one lower through hole and the through hole of the cover.

### FIELD OF THE INVENTION

The present invention generally relates to an apparatus for cleaning an article, such as optical elements, semiconductor wafers, and substrates, etc.

### DESCRIPTION OF RELATED ART

Nowadays, optical elements such as lenses are commonly used in digital cameras or digital video recorders. A film such as an antireflective film or an infrared cut film is generally formed on the optical elements, especially on the lens. To improve imaging quality, it is important to wash the optical elements before forming films thereon and also after forming the films thereon. In a washing process, the optical elements are supported using an apparatus and then washed using a suitable liquid.

Referring to FIG. 12, a typical apparatus 400 for cleaning optical elements is shown. The apparatus 400 includes three clamping poles 402, 404, and 406. The distance between poles can be adjusted. Each of the poles 402 and 404 has a plurality of V-shaped protrusions 408. In the washing process, the optical elements 410 are clamped by the poles 402, 404, and 406 from three directions (i.e., left side, right side and from below), and are then washed using a liquid.

However, the V-shaped protrusions 408 may block the liquid, and part of the optical elements 410 contacting the protrusions 408 is left un-cleaned. Furthermore, when the optical elements 410 are clamped loosely, they may become separated from the apparatus 400. When the optical elements 410 are clamped firmly, it is difficult to remove them from the apparatus 400 after washing and the optical elements 410 may be damaged during removal.

It is therefore desirable to find a new apparatus which can overcome the above mentioned problems.

### SUMMARY OF THE INVENTION

In a preferred embodiment, an apparatus for cleaning an article includes a main body and a cover. The main body defines at least one upper through hole and at least one lower through hole in communication with the at least one upper through hole. The at least one upper through hole is configured for accommodating the article. The cover defines at least one through hole. The at least one through hole spatially corresponds to the at least one upper through hole of the main body. The main body and the cover are configured for attachment to each other in a manner such that the at least upper through hole of the main body is aligned with the at least one through hole of the cover. The at least one upper through hole is of such dimensions that the article accommodated therein is held from falling out through the at least one lower through hole and the through hole of the cover.

### BRIEF DESCRIPTION OF THE DRAWINGS

Many aspects of embodiments can be better understood with reference to the following drawings. The components in the drawings are not necessarily drawn to scale, the emphasis instead being placed upon clearly illustrating the principles of the present embodiment. Moreover, in the drawings, like reference numerals designate corresponding parts throughout the several views.

FIG. 1 is a schematic, cross-sectional view of an apparatus according to a first embodiment;

FIG. 2 is a schematic, plan view of a cover of the apparatus of FIG. 1;

FIG. 3 is a schematic, plan view of a main body of the apparatus of FIG. 1;

FIG. 4 is a schematic, cross-sectional view of the main body of FIG. 3;

FIG. 5 is a schematic, cross-sectional view of the apparatus of FIG. 1, fixed by a plurality of screws, together with a plurality of optical elements;

FIG. 6 is a schematic, cross-sectional view of the apparatus of FIG. 1, fixed by a plurality of clamps 124, together with a plurality of optical elements;

FIG. 7 is a schematic, plan view of a cover of an apparatus according to a second embodiment;

FIG. 8 is a schematic, plan view of a main body of an apparatus according to the second embodiment;

FIG. 9 is a schematic, cross-sectional view of an apparatus according to a third embodiment;

FIG. 10 is a schematic, cross-sectional view of the apparatus of FIG. 9 fixed by a plurality of screws, together with a plurality of optical elements;

FIG. 11 is a schematic, cross-sectional view of an apparatus according to a fourth embodiment; and

FIG. 12 is a use state, isometric view of a typical apparatus, together with a plurality of optical elements.

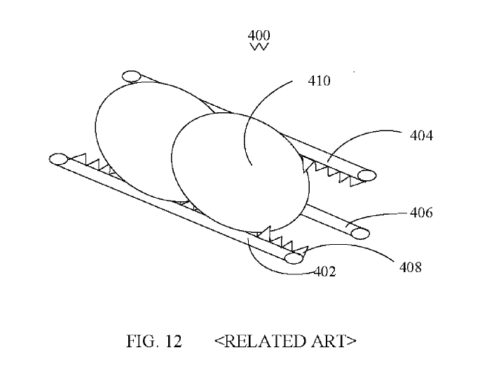

### DETAILED DESCRIPTION OF THE INVENTION

Embodiments will now be described in detail below with reference to the drawings.

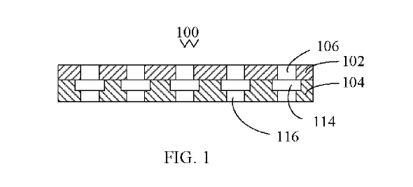

Referring to FIG. 1, an apparatus 100 for cleaning for example an optical element is shown in accordance with a first embodiment. The apparatus 100 includes a main body 104 and a cover 102. The material of the apparatus 100 can be selected from the group consisting of: aluminium, aluminium alloy, titanium alloy, steel, and engineering plastic. The apparatus 100 can be manufactured using computer numerical control (CNC) technology.

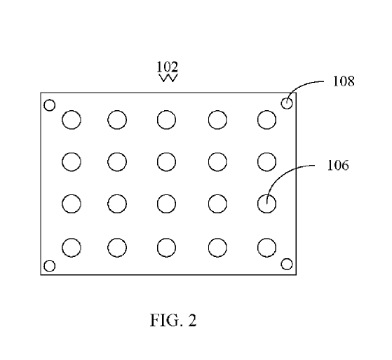

Referring to FIG. 2, the cover 102 defines a plurality of though holes 106 and four top latch holes 108. Each top latch hole 108 is arranged at a corner of the cover 102. Every two adjacent through holes 106 are spaced apart from each other, and are spaced apart evenly in this embodiment.

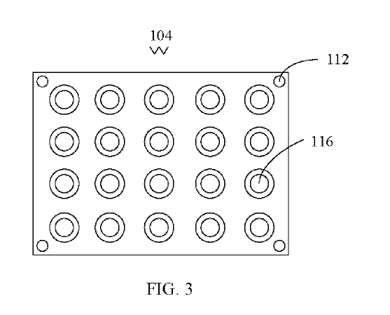

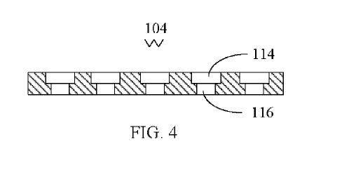

Referring to FIGS. 3 and 4, the main body 104 defines a plurality of upper through holes 114, a plurality of lower through holes 116, and four bottom latch holes 112. The upper through holes 114 are configured for accommodating to-be-washed optical elements. Each bottom latch holes 112 is arranged at each corner of the cover 102. Each pair of the upper through holes 114 and the lower through holes 116 can be concentric and shaped and positioned corresponding to the through hole 106 (referring to FIG. 1). In this embodiment, all the upper through holes 114 and the lower through holes 116 are circular.

Referring to FIG. 1 again, the through holes 106 can have the same diameter as the lower through holes 116. When the optical elements are circular in cross-section, the through holes 106 and the lower through holes 116 both have smaller diameters than the optical elements, while the upper through holes 114 have larger diameters than the optical elements. The upper through holes 114 are deeper than the thickness of the optical elements. For example, the optical element has a diameter of 3.5 millimeters (mm) and a thickness of 0.3 mm. The diameter of the through hole 106 can be 3.2+0.1 mm, and the diameter of the lower through hole 116 can be 3.2+0.1 mm. The diameter of the upper through hole 114 can be 3.7+0.1 mm. The depth of the lower through hole 116 can be 0.6+0.1 mm, and the depth of the upper through hole 114 can be 0.6+0.1 mm.

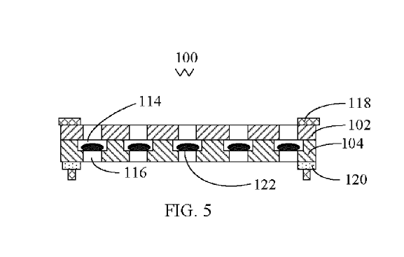

Referring to FIG. 5, the apparatus 100 incorporates the main body 104 and the cover 102 in such a manner that the upper through holes 114 are closer to the cover 102 than the lower through holes 116. The cover 102 can be fastened to the main body 104 in such a manner that each screw 118 extends through the top latch hole 108 and the bottom latch hole 112 and engages with a screw cap 120. In this way, the main body 104 and the cover 102 cooperatively define a plurality of chambers (i.e., the upper through holes 114) for accommodating optical elements 122. The chambers are of such dimensions that the optical elements 122 are kept from falling out. In operation, optical elements 122 are first placed into the upper through holes 114, and then the cover 102 is incorporated to the main body 104 and fastened. In this position, the washing can take place.

With the above-described configuration, the upper through holes 114 accommodate the optical elements 122 and the apparatus 100 prevents optical elements 122 from dropping out. In addition, after the optical elements 122 are washed, they can be conveniently removed by separating the cover 102 from the main body 104. Furthermore, a washing liquid goes through the upper through holes 114 and cleans the optical elements 122 thoroughly during washing process.

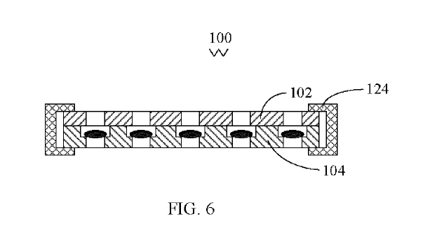

It should be noted that the cover 102 can be fastened to the main body 104 using at least one clamp 124, referring to FIG. 6.

It should be noted that the through holes 106 in the cover 102 can be square, rectangular, triangular, or diamond-shaped.

It should be noted that the upper through holes 114 and the lower through holes 116 in the main body 104 can be square, rectangular, triangular, or diamond-shaped.

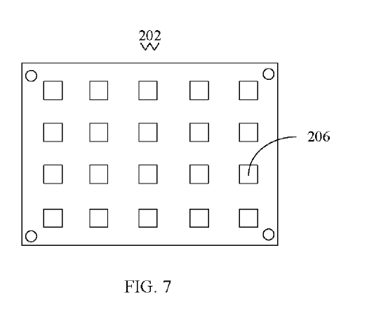

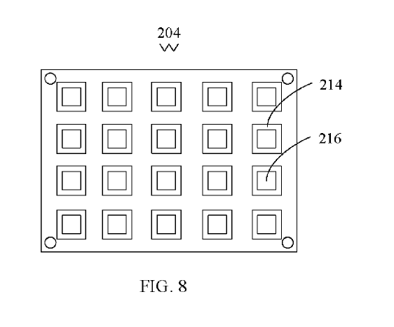

Referring to FIGS. 7 and 8, a cover 202 and a main body 204 of an apparatus is shown in accordance with a second embodiment. The apparatus has a same cross-sectional view as the apparatus 100, referring to FIG. 1. The cover 202 is similar to the cover 102 of the apparatus 100, but the through holes 206 are square. The main body 204 is similar to the main body 104 of the apparatus 100, but the upper through holes 214 and the lower through holes 216 are square.

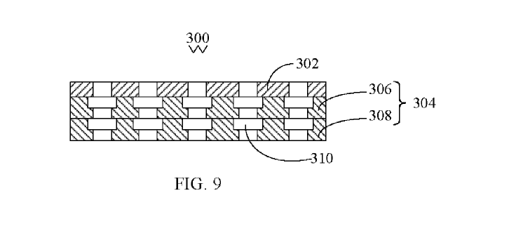

Referring to FIG. 9, an apparatus 300 is shown in accordance with a third embodiment. The apparatus 300 is similar to the apparatus 100, but the main body 304 includes two parts 306 and 308 both similar to the main body in FIG. 1. A first part 308 overlapped a second part 306 in such a manner that an upper through hole 310 in the first part 308 is closer to the second part 306. It should be noted that the main body can include more than two parts.

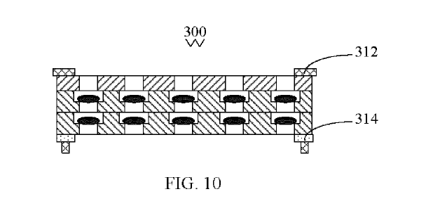

Referring to FIG. 10, a use state of the apparatus 300 is shown. The apparatus 300 incorporates the main body 304 and the cover 302 using screws 312 and screw caps 314.

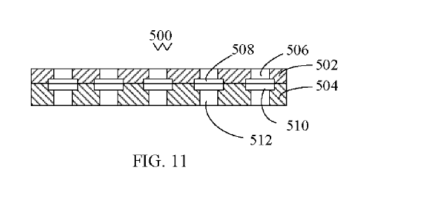

Referring to FIG. 11, an apparatus 500 is shown in accordance with a fourth embodiment. The apparatus 500 is similar to the apparatus 100, but the cover 502 defines at least one upper through hole 506, and at least one lower through hole 508. The main body 504 defines at least one upper through hole 510, and at least one lower through hole 512. The hole 506 is in communication with the hole 508, 510, and 512. The cover 502 is attached to the main body 504 in a manner such that the cover 502 and the main body 504 cooperatively define at least one chamber (not labeled). The chamber is configured for accommodating an optical element, and is of such dimensions that the optical element is kept from falling out through the holes 506 and 512.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An apparatus for cleaning an article, comprising:
a main body defining at least one upper through hole and at least one lower through hole in communication with the at least one upper through hole, the at least one upper through hole being configured for accommodating the article;
and a cover defining at least one through hole, the at least one through hole spatially corresponding to the at least one upper through hole,
wherein the main body and the cover are configured for attachment to each other in a manner such that the at least upper through hole of the main body is aligned with the at least one through hole of the cover, and the at least one upper through hole is of such dimensions that the article accommodated therein is held from falling out through the at least one lower through hole and the through hole of the cover.

2. The apparatus as claimed in claim 1, wherein a shape of a cross section of the upper through hole is selected from the group consisting of circular and square.

3. The apparatus as claimed in claim 1, wherein a shape of a cross section of the lower through hole is selected from the group consisting of circular and square.

4. The apparatus as claimed in claim 1, wherein a shape of a cross section of the through hole is selected from the group consisting of circular and square.

5. The apparatus as claimed in claim 1, wherein the upper through hole and the lower through hole are concentric.

6. The apparatus as claimed in claim 5, wherein the upper through hole and the through hole are concentric.

7. The apparatus as claimed in claim 1, wherein the main body is fastened to the cover by means of at least a fastener.

8. The apparatus as claimed in claim 1, wherein the cover is secured to the main body using at least one clamp.

9. An apparatus for cleaning an article, comprising:
a first part defining at least one first through hole; and
a second part defining at least one second through hole; the first part being configured for attachment to the second part in a manner such that the first part and second part cooperatively defining at least one first chamber, the at least one first chamber being in communication with the at least one first through hole and the at least one second through hole, the at least one first chamber being of such dimensions that the article is held therein thereby being kept from falling out through the at least one of the first and second through hole.

10. The apparatus as claimed in claim 9, further comprising a third part defining at least one third through hole, the third part being configured for attachment to the second part in a manner such that the third part and second part cooperatively defining at least one second chamber, the at least one second chamber being in communication with the at least one third through hole and the at least one second through hole, the at least one second chamber being of such dimensions that the article is held therein thereby being kept from falling out through the third through hole.

11. The apparatus as claimed in claim 9, wherein a shape of a cross section of the first through hole is selected from the group consisting of circular and square.

12. The apparatus as claimed in claim 9, wherein a shape of a cross section of the second through hole is selected from the group consisting of circular and square.

13. The apparatus as claimed in claim 10, wherein a shape of a cross section of the third through hole is selected from the group consisting of circular and square.

14. The apparatus as claimed in claim 9, wherein the first through hole and the second through hole are concentric.

15. The apparatus as claimed in claim 10, wherein the first through hole and the third through hole are concentric.

16. The apparatus as claimed in claim 9, wherein the second part is fastened to the first part by means of at least a fastener.

17. The apparatus as claimed in claim 9, wherein the second part is secured to the first part using at least one clamp.

18. The apparatus as claimed in claim 9, wherein the third part is fastened to the first part by means of at least a fastener.

19. The apparatus as claimed in claim 9, wherein the third part is secured to the first part using at least one clamp.
